(19) United States
(12) Patent Application Publication
(10) Pub. No.: US 2020/0385117 A1
(43) Pub. Date: Dec. 10, 2020

(54) FUEL-ELECTRIC HYBRID MULTI-AXIS ROTOR-TYPE UNMANNED AERIAL VEHICLE

(71) Applicant: HENAN PREDATOR FIREPROOFING TECHNOLOGY CO., LTD., Zhengzhou, Henan (CN)

(72) Inventor: Wanmin ZHANG, Zhengzhou (CN)

(73) Assignee: HENAN PREDATOR FIREPROOFING TECHNOLOGY CO., LTD., Zhengzhou, Henan (CN)

(21) Appl. No.: 16/624,258

(22) PCT Filed: Jun. 15, 2018
(86) PCT No.: PCT/CN2018/091600

§ 371 Date: Dec. 18, 2019

(30) Foreign Application Priority Data
Jun. 19, 2017 (CN) 201720711255.8

(51) Int. Cl. B64C 39/02; B64C 27/10; B64C 27/52; B64D 27/02; B64D 37/04; B64D 41/00

(52) U.S. Cl. CPC B64C 39/024; B64C 27/10; B64C 27/52; B64D 27/02; B64D 37/04; B64D 2027/026; B64C 2201/027; B64C 2201/04; B64C 2201/066; B64C 2201/108; B64D 41/00

(57) ABSTRACT

The present invention discloses a fuel-electric hybrid multi-axis rotor-type unmanned aerial vehicle which relates to the field of unmanned aerial vehicles. The fuel-electric hybrid multi-axis rotor-type unmanned aerial vehicle includes an unmanned aerial vehicle frame, a lifting rotor, a posture adjusting rotor, a fuel engine, a motor, a fuel tank and a power supply device; the fuel engine, the motor, the fuel tank and the power supply device are mounted on the unmanned aerial vehicle frame; the fuel tank supplies fuel to the fuel engine; the fuel engine is configured to drive the lifting rotor; and the motor is powered by the power supply device and configured to drive the posture adjusting rotor. A main purpose is to enable the multi-axis rotor-type unmanned aerial vehicle having a large-load and long-duration flight function to quickly and precisely adjust the flight direction and flight speed.

### CROSS-REFERENCE TO RELATED APPLICATIONS

This application is the U.S. national phase of PCT application No. PCT/CN2018/091600 filed on Jun. 15, 2018, which claims a priority to Chinese Patent Application No. 201720711255.8 filed on Jun. 19, 2017, the disclosures of which are incorporated in their entireties by reference herein.

### TECHNICAL FIELD

The present invention relates to the field of unmanned aerial vehicles, and specifically to a fuel-electric hybrid multi-axis rotor-type unmanned aerial vehicle.

### BACKGROUND

A multi-axis rotor-type unmanned aerial vehicle powered by brushless motor is advantageous in sensitive response and capability of achieving precise control, and disadvantageous in failing to achieve large-load and long-duration flight due to limitations of an energy ratio of the battery per unit of mass. Although a multi-axis electric rotor-type unmanned aerial vehicle can be enabled to perform large-load and long-duration airborne flight by using a power supply wire connected to a ground high-voltage power supply in a dragged manner, the flying height and the working space are limited by the weight and length of the power supply wire itself. At the same time, due to the impact of wind on the power supply wire, the stability of this type of unmanned aerial vehicle will be seriously affected.

An unmanned helicopter with a fuel engine is advantageous in achieving large-load and long-duration flight, but obviously disadvantageous for example in exhibiting slow start and stop and a response lag, and causing the flying posture and flying speed difficult to be adjusted in position quickly, and having difficulty in achieving precise control.

After performing a search, the Inventor knows that those skilled in the art have already performed the following research of fuel-electric hybrid unmanned aerial vehicles.

The Chinese patent document CN206107565U published on Aug. 30, 2016 discloses a hybrid unmanned aerial vehicle, comprising a vehicle body, a power device disposed on the vehicle body, a transmission device and a rotor set, and further comprising a control system to control the operation of the unmanned aerial vehicle, wherein the vehicle body comprises a primary frame and a second frame which are connected to each other, the rotor set comprises several primary rotors and several secondary rotors, a primary rotor is disposed respectively at each end of the primary frame which forms a pair of primary rotors, a secondary rotor mounting bracket is disposed respectively at each end of the secondary frame, and a secondary rotor is disposed respectively at each end of the secondary rotor mounting bracket which forms two pairs of secondary rotors; the power device comprises fuel engines and motors, a fuel engine is disposed respectively at each end of the primary frame to drive the primary rotors at corresponding positions, and a motor is disposed respectively at each end of the secondary rotor mounting bracket to drive the secondary rotors at corresponding positions; the transmission device comprises primary transmission mechanisms and secondary transmission mechanisms, a primary transmission mechanism is disposed respectively at each end of the primary frame to connect the fuel engine at the corresponding position with the primary rotor so that the fuel engine drives the primary rotor, a secondary transmission mechanism is disposed respectively at each end of the secondary rotor mounting bracket to connect the electric motor at the corresponding position with the secondary rotor so that the electric motor drives the secondary rotor, the vehicle body is mounted with a battery and a fuel tank, the electric motor is powered by the battery, and the fuel tank supplies fuel to the fuel engine. A technical problem solved by the technical solution is an undesirable effect of flight stability of a fuel-electric hybrid unmanned aerial vehicle.

Among published Chinese patent applications obtained from the search, the Chinese patent document CN205418106U published on Aug. 3, 2016 discloses a ducted fixed-wing fuel-electric hybrid unmanned aerial vehicle of which the wing is fixed; the Chinese patent document CN205499385U published on Aug. 24, 2016 discloses a fuel-electric hybrid unmanned aerial vehicle which may implement quick fuel-electric conversion by employing a fuel-electric conversion device, thereby achieving a purpose of increasing cruising duration of the unmanned aerial vehicle; the Chinese patent document CN105882954A published on Aug. 24, 2016 discloses a hybrid unmanned aerial vehicle with four auxiliary rotors and a control method thereof, and designs a vertical takeoff and landing unmanned aerial vehicle with a fuel-electric hybrid system and with a helicopter architecture as a primary unit and a four-rotor architecture as a secondary unit. The unmanned aerial vehicle employs a helicopter as a basic architecture on the whole, the primary rotors of the helicopter are changed to ordinary fixed-pitch blades, and the control of the flight direction and maneuver of the unmanned aerial vehicle is completed by a vertical tail and four auxiliary rotors. The primary rotors of the invention are powered by an internal combustion engine, and other rotors are powered by a brushless motor.

The Chinese patent document CN104823589A published on Aug. 12, 2015 discloses a transmission mechanism for implementing coaxial forward/reverse rotation, comprising a motor, a gearbox, a large rotary disk, a small rotary disk, and an output shaft of the motor being coaxially fixed with the small rotary disk; a central gear, a planetary gear, an inner ring and a planet carrier in the gearbox form a planet gear mechanism; the central gear is coaxially fixed with the output shaft of the motor, the inner gear is coaxially fixed with the gearbox and coaxially arranged with the central gear, two planet gears are symmetrically arranged on both sides of the central gear and mesh with the central gear and inner gear; two planet gear shafts are respectively coaxially fixed with the two planet gears and fixed at both ends of the planet carrier, and the planet carrier is coaxially arranged with the central gear. An output shaft of the planet carrier is a hollow shaft sleeved on the output shaft of the motor. The output shaft of the motor, the output shaft of the planet carrier, the gearbox, the large rotary disk and the small rotary disk are all coaxially mounted.

### SUMMARY

A fuel-electric hybrid multi-axis rotor-type unmanned aerial vehicle using a fuel engine to provide power for a primary motor which controls ascent and descent and using a battery or a generator to power a multi-axis auxiliary rotor which controls balance, direction and flight speed may be employed to achieve large-load and long-duration flight and precise control of the fuel-electric hybrid multi-axis rotor-type unmanned aerial vehicle, greatly expand the application space of the fuel-electric hybrid multi-axis rotor-type unmanned aerial vehicle, and promote fast development of the operation of unmanned aerial vehicles.

An object of the present invention is to provide a fuel-electric hybrid multi-axis rotor-type unmanned aerial vehicle, to enable a multi-axis rotor-type unmanned aerial vehicle to have less weight and a lower flight accident rate, without reducing the flight duration and the flight trajectory precision.

To solve the above technical problem, the present invention employs the following technical solutions:

A fuel-electric hybrid multi-axis rotor-type unmanned aerial vehicle comprises an unmanned aerial vehicle frame, a lifting rotor, a posture adjusting rotor, a fuel engine, a motor, a fuel tank and a power supply device; the fuel engine, the motor, the fuel tank and the power supply device are mounted on the unmanned aerial vehicle frame; the fuel tank supplies fuel to the fuel engine; the fuel engine is configured to drive the lifting rotor; and the motor is powered by the power supply device and configured to drive the posture adjusting rotor.

Preferably, the posture adjusting rotor comprises a fixing portion and blades, and a longitudinal section of the blades is a side-tilted “V” shape; or the posture adjusting rotor comprises a first upper rotor and a first lower rotor that are coaxially disposed, blades of the first upper rotor and the first lower rotor are oppositely disposed and have opposite spiral directions such that the corresponding first upper rotor and first lower rotor form a constriction. In this way, when the posture adjusting rotors rotate, the wind propelling effect is better, and the fuel-electric hybrid multi-axis rotor-type unmanned aerial vehicle can change directions quickly and fly at a fast speed.

Preferably, the lifting rotor comprises a second upper rotor and a second lower rotor which are coaxially disposed, spiral directions of the blades of the second upper rotor and the second lower rotor are the same, and upon operation, the second upper rotor and the second lower rotor rotate in opposite directions. As such, the fuel-electric hybrid multi-axis rotor-type unmanned aerial vehicle has a large load and can avoid a gyro effect caused by a high torque.

Preferably, in order to enhance the flight stability of the fuel-electric hybrid multi-axis rotor-type unmanned aerial vehicle, the fuel-electric hybrid multi-axis rotor-type unmanned aerial vehicle comprises 2n posture adjusting rotors, wherein n is a natural number, and n≥2, and the posture adjusting rotors are disposed at vertices of a regular 2n-gon; the fuel-electric hybrid multi-axis rotor-type unmanned aerial vehicle comprises one lifting rotor, and the lifting rotor is disposed on a mid-perpendicular of the regular 2n-gon.

Preferably, in order to facilitate mounting an external device, an external mounting platform for mounting the external device is disposed below the unmanned aerial vehicle frame.

Preferably, the power supply device comprises a generator that is drivingly connected to the fuel engine and electrically connected to the motor.

Furthermore, the fuel tank is an annular fuel tank, the generator is disposed in an inner ring of the fuel tank, an output shaft of the fuel engine is coaxially with a transmission shaft of the generator, the external mounting platform for mounting the external device is arranged below the unmanned aerial vehicle frame, and the external mounting platform is disposed below the annular fuel tank. In this way, the thickness of the fuel tank and the generator can be made coincide, and the thickness of the fuel-electric hybrid multi-axis rotor-type unmanned aerial vehicle can be reduced. A center of gravity of the fuel-electric hybrid multi-axis rotor-type unmanned aerial vehicle is on a central axis of the unmanned aerial vehicle and below a center of the central axis of the unmanned aerial vehicle, and the external mounting platform can protect the fuel tank.

Furthermore, to prevent the fuel-electric hybrid multi-axis rotor-type unmanned aerial vehicle from freely falling down in the air after the fuel engine exhausts fuel, the power supply device comprises a rechargeable battery, the generator powered the rechargeable battery, and the rechargeable battery supplies power to the motor. As such, after the fuel is exhausted, the rechargeable battery can be used as a backup power supply to drive the posture adjusting rotor to rotate to lower the falling speed.

Preferably, the unmanned aerial vehicle frame is pivotally connected with a side arm having a locking function, and the motor is fixed on the side arm.

As compared with the prior art, the invention has the following advantageous effect: it is possible to, by using the fuel engine to drive the lifting rotor and using the motor to drive the posture adjusting rotor, fully utilize a high power of the fuel engine and a quick start and stop effect of the motor, so that the multi-axis rotor-type unmanned aerial vehicle having a large-load and long-duration flight function can quickly and precisely adjust a flight direction and flight speed.

### BRIEF DESCRIPTION OF THE DRAWINGS

FIG. 1 is a schematic structural view of a first embodiment of a fuel-electric hybrid multi-axis rotor-type unmanned aerial vehicle of the present invention;

FIG. 2 is a top view of FIG. 1;

FIG. 3 is a cross-sectional view taken along line A-A of FIG. 2;

FIG. 4 is a schematic structural view of a second embodiment of a fuel-electric hybrid multi-axis rotor-type unmanned aerial vehicle of the present invention;

FIG. 5 is a top view of FIG. 4;

FIG. 6 is a cross-sectional view taken along line B-B of FIG. 5.

In the figures, 1 represents a housing, 2 represents a lifting rotor, 21 represents a second upper rotor, 22 represents a second lower rotor, 3 represents a posture adjusting rotor, 31 represents a first upper rotor, 32 represents a first lower rotor, 4 represents a fuel engine, 5 represents a generator, 6 represents a fuel tank, 7 represents an engine bracket, 8 represents a motor, 9 represents an external mounting platform, 10 represents a side arm, 11 represents a main support, 12 represents a pivot shaft, 13 represents a battery.

### DETAILED DESCRIPTION

Specific implementations of the present invention are described in detail below with reference to the figures and embodiments, but the following embodiments are only intended to illustrate the present invention in detail not to limit the scope of the present invention in any manner.

### Embodiment 1

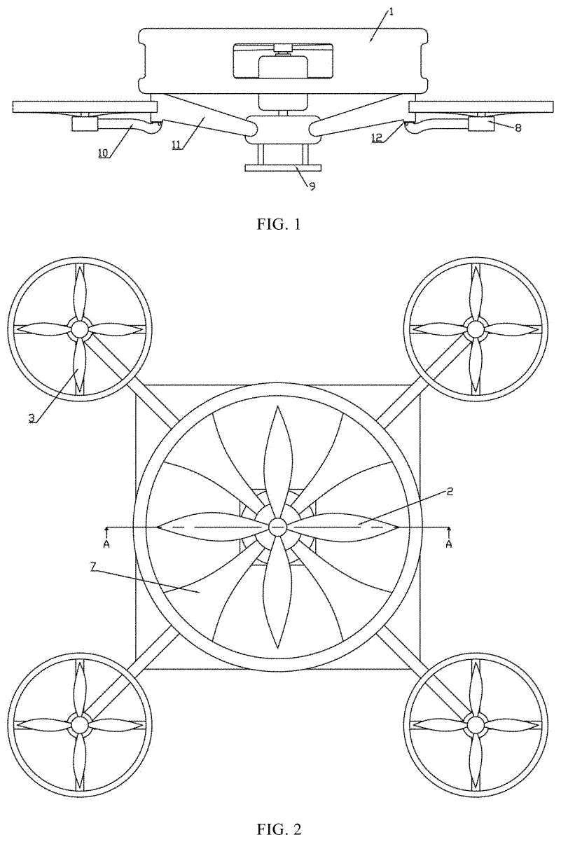

a fuel-electric hybrid multi-axis rotor-type unmanned aerial vehicle, as shown in FIGS. 1-3, comprises an unmanned aerial vehicle frame, a lifting rotor 2, a posture adjusting rotor 3, a fuel engine 4, a motor 8, a fuel tank 6 and a power supply device; the fuel engine 4, the generator 5, the fuel tank 6 and the power supply device are mounted on the unmanned aerial vehicle frame. The fuel tank 6 supplies fuel to the fuel engine 4, generally, a fuel inlet pipe of the fuel engine 4 is disposed at a bottom of the fuel tank 6; the fuel engine 4 is used to drive the lifting rotor 2, and generally, the lifting rotor 2 is connected with an output shaft of the fuel engine 4 via gear transmission; a motor 8 is powered by the power supply device and used to drive the posture adjusting rotor 3.

In the present embodiment, the unmanned aerial vehicle frame comprises a housing 1, an engine bracket 7, a side arm 10 and a main support 11. Four posture adjusting rotors 3 are provided. The four posture adjusting rotors 3 are disposed at the vertices of a regular quadrilateral (i.e., n=2). Only one lifting rotor 2 is provided, and the lifting rotor 2 is disposed on a mid-perpendicular line of a regular quadrilateral, i.e., the rotation axis of the lifting rotor 2 coincides with the mid-perpendicular line of the regular quadrilateral. In FIG. 1, a height of the lifting rotor 2 is higher than a height of the posture adjusting rotor 3. In order to adapt for the positional relationship between the lifting rotor 2 and the posture adjusting rotor 3, the housing 1 is annular, one end of the engine bracket 7 is connected inside the housing 1, and the fuel engine 4 is mounted on the engine bracket 7 and fixed at a center of the housing 1 via the engine bracket 7; the housing 1 is fixed with four side arms 10 outside respectively so that the posture adjusting rotor 3 is disposed at vertices of the regular quadrilateral via the motor 8. Generally, the motor 8 is mounted on the side arms 10, and the posture adjusting rotor 3 is mounted on the output shaft of the motor 8. One end of the main support 11 is fixed to a bottom surface of the housing 1, and the other end is used to lift the engine bracket 7.

In the present embodiment, in order to facilitate mounting an external device, an external mounting platform 9 for mounting the external device is disposed below the unmanned aerial vehicle frame. The external mounting platform 9 may be mounted as needed and equipped with a variety of auxiliary devices to meet the needs of different scenarios, for example, a fire extinguishing kit or a pressurized spraying device can be equipped for fire fighting in a space outside in high-rise buildings. As shown in FIG. 1, the external mounting platform 9 is mounted on a bottom surface of the main support 11. This facilitates securing an external device below the external mounting platform 9 for convenient use.

In the present embodiment, the power supply device comprises a battery 13 electrically connected to the motor 8. When a model of the battery 13 is selected, a balance between a capacity and a weight of the battery 13 should be achieved as much as possible. In FIG. 3, the battery 13 is disposed in the main support 11.

An operation process of the above-mentioned fuel-electric hybrid multi-axis rotor-type unmanned aerial vehicle is as follows: the fuel tank 6 is filled up with fuel oil, the fuel engine 4 takes fuel oil from the fuel tank 6 and outputs rotary power to drive the lifting rotor 2 to rotate, and the lifting rotor 2 functions to make the fuel-electric hybrid multi-axis rotor-type unmanned aerial vehicle rise, fall or get airborne; the power supply device supplies power to the motor 8, and the motor 8 outputs rotary power to drive the posture adjusting rotor 3 to rotate; the posture adjusting rotor 3 functions to adjust a flight posture and flight speed of the fuel-electric hybrid multi-axis rotor-type unmanned aerial vehicle to achieve a purpose of adjusting the flight direction and flight speed. Due to a large thrust of the fuel engine and the quick start and stop of the motor, the multi-axis rotor-type unmanned aerial vehicle with a large-load and long-time flight function utilizing foregoing characteristics can quickly and accurately adjust the flight direction and flight speed. When an external device need to be mounted, the external mounting platform 9 may be mounted on the main support, and then the external device is fixed on the external mounting platform 9.

### Embodiment 2

A fuel-electric hybrid multi-axis rotor-type unmanned aerial vehicle, as shown in FIG. 1-3, serving as another implementation of Embodiment 1, the power supply device comprises a generator 5, and the generator 5 is drivingly connected to the fuel engine 4. As such, the fuel engine 4 drives the generator 5 to generate electricity while powering the lifting rotor 2, and the generator 5 is electrically connected to the motor 8. In the present embodiment, the fuel tank 6 is an annular fuel tank, the generator 5 is disposed in an inner ring of the fuel tank 6, an output shaft of the fuel engine 4 is connected with a transmission shaft of the generator 5 through a coupling, and the lifting rotor 2 is mounted on the output shaft on the fuel engine 4, that is, the fuel engine 4, the generator 5 and the primary rotor 2 are coaxial, the external mounting platform 9 for mounting the external device is arranged below the unmanned aerial vehicle frame, and the external mounting platform 9 is disposed below the fuel tank 6. In this way, the thickness of the fuel tank and the generator can be made coincide, and a thickness of the fuel-electric hybrid multi-axis rotor-type unmanned aerial vehicle can be reduced. A center of gravity of the fuel-electric hybrid multi-axis rotor-type unmanned aerial vehicle is on a central axis of the unmanned aerial vehicle and below a center of the central axis of the unmanned aerial vehicle. In this way, when the fuel-electric hybrid multi-axis rotor-type unmanned aerial vehicle loses power, the external mounting platform will land first and can protect the fuel tank.

### Embodiment 3

A fuel-electric hybrid multi-axis rotor-type unmanned aerial vehicle, as shown in FIG. 1-3, serve as a further improvement of Embodiment 1 or 2. The power supply device comprises a generator 5 and a battery 13, wherein the battery 13 is a rechargeable battery, and the generator 5 is drivingly connected to the fuel engine 4. Reference may be specifically made to Embodiment 2. The generator 5 charges the battery 13, and the battery 13 supplies power to the motor 8. Specifically, the generator 5 and the battery 13 may be connected to an input end of a dual power supply switching system, and output ends of the dual power supply switching system are electrically connected to four generators 5, respectively. It is also possible that the generator 5 is electrically connected to the battery 13 to form a charging circuit, and the battery 13 is electrically connected to the four generators 5, respectively, to form a discharge circuit. As such, after fuel is exhausted, the rechargeable battery may act as a backup power supply to drive the posture adjusting rotor 3 to rotate to reduce the descending speed. The battery 13 should automatically switch in linkage to power the posture adjusting rotor 3 to maintain a balance and a descending speed not greater than a maximum allowable designed speed when the lifting rotor 2 of the fuel-electric hybrid multi-axis rotor-type unmanned aerial vehicle loses power.

### Embodiment 4

a fuel-electric hybrid multi-axis rotor-type unmanned aerial vehicle, as shown in FIG. 1-3, is considered as a further improvement to the Embodiment 1, 2 or 3. The unmanned aerial vehicle frame is pivotally connected with side arm 10 having a locking function, corresponding to FIG. 1, the main support 11 is provided with a pivot hole, one end of the side arm 10 is provided with a pivot shaft 12, the pivot shaft 12 is pivotally mounted in the pivot hole, and the motor 8 is fixed to the side arm 10. A locking function of the side arm 10 and the main support 11 is realized by providing pin holes on sides of the pivot hole and the pivot shaft 12 to mount pins, wherein one pin hole is disposed when the side arm 10 retracts under the housing 1, and a pin is inserted into the pin hole to lock the side arm 10 in a retracted state, and wherein the other pin hole is disposed when the side arm 10 is in a deployed state in operation, and the pin is inserted into the pin hole to lock the side arm 10 in the deployed state.

It should be appreciated that in order to enhance the flight stability of the fuel-electric hybrid multi-axis rotor-type unmanned aerial vehicle, the number of the posture adjusting rotors 3 may be set to 2n, wherein n is a natural number, and such as six-axis, eight-axis and other even number axis, to increase a operating power. These posture adjusting rotors 3 are disposed at vertices of a regular 2n-gon; the number of the lifting rotor 2 is not limited to one, but a center of the lifting rotor 2 and centers of the posture adjusting rotors 3 should be located as much as possible on a perpendicular where a center of gravity of the fuel-electric hybrid multi-axis rotor-type unmanned aerial vehicle lies.

### Embodiment 5

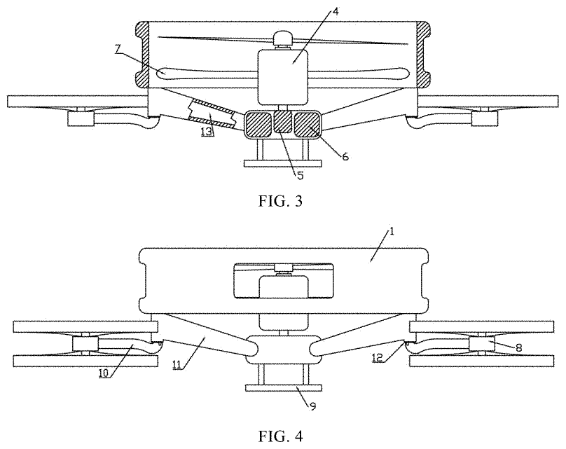

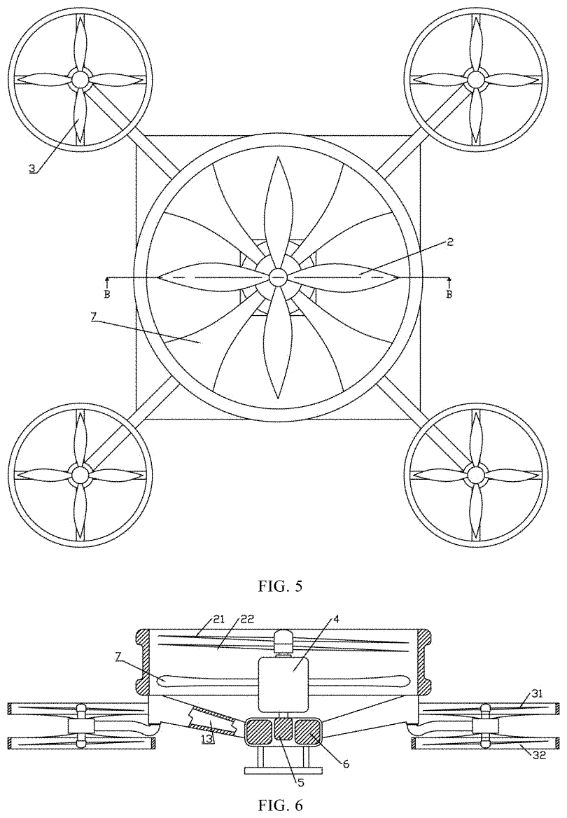

A fuel-electric hybrid multi-axis rotor-type unmanned aerial vehicle, as shown in FIGS. 4-6, is considered as a further improvement of any of Embodiments 1-4. The present embodiment differs from Embodiments 1-4 as follows. In the present embodiment, the posture adjusting rotor 3 comprises a fixing portion and blades, and the posture adjusting rotor 3 may also be disposed such that a longitudinal section of the blades is a side-tilted “V” shape; or, the posture adjusting rotor 3 comprises a first upper rotor 31 and a first lower rotor 32 that are coaxially disposed, and the blades of the first upper rotor 31 and the first lower rotor 32 are oppositely disposed and have opposite spiral directions so that the corresponding first upper rotor 31 and first lower rotor 32 form a constriction. Specifically, the first upper rotor 31 and the first lower rotor 32 may be disposed adjacent to each other, or may be respectively disposed on upper and lower sides of the side arm 10, as shown in FIG. 6. The blades of the first upper rotor 31 and the first lower rotor 32 are generally in same size such that projections of the first upper rotor 31 and the first lower rotor 32 on the ground coincide, but spiral directions of the blades of the rotors are opposite. In this way, when the posture adjusting rotors rotate, a wind propelling effect is better, and the fuel-electric hybrid multi-axis rotor-type unmanned aerial vehicle can change directions quickly and fly at a fast speed.

In the present embodiment, the lifting rotor 2 may also be disposed comprising a second upper rotor 21 and a second lower rotor 22 which are coaxially disposed, and the spiral directions of the blades of the second upper rotor 21 and the second lower rotor 22 are the same. Upon operation, the second upper rotor 21 and the second lower rotor 22 rotate in opposite directions. A structure for realizing opposite rotation directions of the second upper rotor 21 and the second lower rotor 22 can be found in Chinese patent document No. CN104823589A relating to a transmission mechanism for implementing coaxial forward/reverse rotation as described in Background. As such, the load is increased and a gyro effect caused by a high torque is avoided.

The above-mentioned multi-axis rotor-type unmanned aerial vehicle may be used for high-rise building fire extinguishing, high-altitude radar search, launching air-to-ground missiles, emergency large-flux wireless signal relay, airborne line inspection, air cargo transportation and other tasks.

The present invention has been described in detail with reference to the figures and embodiments. However, those skilled in the art can understand that without departing from the spirit of the invention, various specific parameters in the above embodiments may be modified to form a plurality of specific embodiments, which are common variations of the present invention, and are not detailed one by one herein.

1. A fuel-electric hybrid multi-axis rotor-type unmanned aerial vehicle wherein comprises an unmanned aerial vehicle frame, a lifting rotor, a posture adjusting rotor, a fuel engine, a motor, a fuel tank and a power supply device; the fuel engine, the motor, the fuel tank and the power supply device are mounted on the unmanned aerial vehicle frame; the fuel tank supplies fuel to the fuel engine; the fuel engine is configured to drive the lifting rotor; and the motor is powered by the power supply device and configured to drive the posture adjusting rotor.

2. The fuel-electric hybrid multi-axis rotor-type unmanned aerial vehicle according to claim 1, wherein the posture adjusting rotor comprises a fixing portion and blades, and a longitudinal section of the blades is a side-tilted “V” shape; or the posture adjusting rotor comprises a first upper rotor and a first lower rotor that are coaxially disposed, blades of the first upper rotor and the first lower rotor are oppositely disposed and have opposite spiral directions such that the corresponding first upper rotor and first lower rotor form a constriction.

3. The fuel-electric hybrid multi-axis rotor-type unmanned aerial vehicle according to claim 1, wherein the lifting rotor comprises a second upper rotor and a second lower rotor which are coaxially disposed, spiral directions of the blades of the second upper rotor and the second lower rotor are the same, the second upper rotor and the second lower rotor rotate in opposite directions.

4. The fuel-electric hybrid multi-axis rotor-type unmanned aerial vehicle according to claim 1, wherein the power supply device comprises a generator that is drivingly connected to the fuel engine and electrically connected to the motor.

5. The fuel-electric hybrid multi-axis rotor-type unmanned aerial vehicle according to claim 4, wherein the fuel tank is an annular fuel tank, the generator is disposed in an inner ring of the fuel tank, an output shaft of the fuel engine is coaxially with a transmission shaft of the generator, the external mounting platform for mounting the external device is arranged below the unmanned aerial vehicle frame, and the external mounting platform is disposed below the annular fuel tank.

6. The fuel-electric hybrid multi-axis rotor-type unmanned aerial vehicle according to claim 4, wherein the power supply device comprises a rechargeable battery, the generator powered the rechargeable battery, and the rechargeable battery supplies power to the motor.

7. The fuel-electric hybrid multi-axis rotor-type unmanned aerial vehicle according to claim 1, wherein comprises 2n posture adjusting rotors, wherein n is a natural number, and n≥2, and the posture adjusting rotors are disposed at vertices of a regular 2n-gon; the fuel-electric hybrid multi-axis rotor-type unmanned aerial vehicle comprises one lifting rotor, and the lifting rotor is disposed on a mid-perpendicular of the regular 2n-gon.

8. The fuel-electric hybrid multi-axis rotor-type unmanned aerial vehicle according to claim 1, wherein an external mounting platform for mounting the external device is disposed below the unmanned aerial vehicle frame.

9. The fuel-electric hybrid multi-axis rotor-type unmanned aerial vehicle according to claim 1, wherein the unmanned aerial vehicle frame is pivotally connected with a side arm having a locking function, and the motor is fixed on the side arm.
